(19) United States
(12) Patent Application Publication
(10) Pub. No.: US 2026/0260089 A1
(43) Pub. Date: Sep. 3, 2026

(54) Contactless Smart Card with Multiple Communicating Electronic Modules

(71) Applicant: SMART PACKAGING SOLUTIONS, Rousset (FR)

(72) Inventors: Guillaume GERIN, Rousset (FR); Yves-Pierre CUENOT, Rousset (FR); Benjamin MEAR, Rousset (FR)

(21) Appl. No.: 19/143,219

(22) PCT Filed: Dec. 27, 2023
(86) PCT No.: PCT/FR2023/000199

§ 371 Date: Jun. 25, 2025

(30) Foreign Application Priority Data
Dec. 29, 2022 (FR) FR2214639

(51) Int. Cl. G06K 19/077; G06K 19/07

(52) U.S. Cl. CPC G06K 19/07794; G06K 19/072; G06K 19/07766; G06K 19/07775

(57) ABSTRACT

The invention relates to a communicating portable object (1) operating in a contactless or mixed contact-and-contactless manner, comprising a body in which a main antenna (8) is integrated which is capable of receiving, by radiofrequency, electrical energy from an external reader and of communicating therewith, and two electronic modules (2, 3) each provided with a dielectric substrate having at least one microelectronic chip connected to an antenna (12, 13) arranged on each module (2, 3) and inductively coupled to the main antenna (8) by means of a secondary antenna (7; 7a, 7b) also integrated in the body, characterised in that the two electronic modules (2, 3) are located in two adjacent cavities (4, 5) located on opposite faces of the body.

The invention relates to secure and communicating portable objects, notably such as smart cards or identification documents, provided with a first microelectronic module with contactless or mixed contact and contactless operation, and with a second electronic module or component, such as a biometric sensor, optionally intended to communicate with the first module. The communicating portable object comprises an antenna integrated with the body of the portable object in order to remotely communicate with a radio frequency reader.

By way of an example and for the simplification of the disclosure, the invention will be described within the context of its application to smart cards, yet without limiting the scope of the invention to this form factor, with the invention being applicable to other portable objects or to other form factors.

However, contactless operation smart cards made in the ISO 7816-2 format constitute the most widespread example of identification cards to which the invention applies.

### PRIOR ART

Most contactless smart cards or dual cards with mixed contact and contactless operation comprise a card body, a single electronic module inserted into a cavity of the card body and provided with a microelectronic chip, and an antenna disposed in the card body and electrically connected to output pads of the microelectronic chip of the single module.

Alternatively, smart cards exist whose antenna in the card body is a main antenna, which is inductively coupled with a radio frequency smart card reader, connected to a secondary antenna, which itself is inductively coupled with the antenna located on the electronic module itself.

The main antenna of the card body is generally formed by turns produced using electrically conductive tracks, produced on an insert or a flexible substrate that is integrated with the card body when the card is assembled.

In order to obtain suitable contactless communication performance capabilities, and in particular a sufficient operating range, the turns of the main antenna must be large, typically in the ID1 format, which corresponds to measurements of 85.60×53.98 mm for the card body. This format is commonly used, notably for bank cards.

In some applications, one or more electronic modules supplementing the main module need to be integrated with the smart card, for example, for integrating biometric sensors capable of collecting biometric information of the user and transmitting it to the main electronic module for biometric identification of the user of the smart card.

In this case, the prior art involves disposing the sensors and the main module on a PCB (“Printed Circuit Board”) type substrate and interconnecting them via physical tracks made of a thin metal layer, or involves directly disposing the physical tracks in the form of a wired connection on a polymer substrate integrated into the structure of the card body. In the first case (PCB), the components, such as the terminal block, used to provide the ISO 7816 contact connection and the biometric sensor, are present on the PCB and the polymer layers are pre-perforated at the site accommodating the two components. In the second case of wired connections, more standard machining operations expose the ends of the connection wires in order to interconnect the smart card and biometric card modules. These arrangements have several disadvantages.

An alternative is taught in document FR 3078422A1, which anticipates positioning two electronic modules either on one face of the smart card or facing each face of the smart card, with the two electronic modules being connected by means of an optical link.

Indeed, the physical interconnection of a plurality of modules is expensive because it requires additional components and the modification of the conventional manufacturing processes for smart cards. The physical (notably galvanic) interconnection of the electronic modules is also not very reliable over time because the repeated bending that the product must experience when it is used risks breaking these interconnections more or less rapidly. These disadvantages explain the reason behind the fact that the market for smart cards provided with biometric sensors or a DCVV display has struggled to take off, notably due to the difficulty in producing multi-module cards industrially and inexpensively.

A portable object is also known from document EP 2098981 A1 comprising a first inductive antenna and a plurality of chips, each comprising an integrated circuit, and a second inductive antenna for electrically powering and communicating with said integrated circuit. Some of the chips are not intended to communicate with an external reader, but only with other chips of the portable object. This document therefore provides an architecture in which the chips can communicate with each other independently, without using the antenna designed to communicate with the outside, but by mutual inductive coupling thereof.

Document FR 2727227 A1 for its part describes a memory active security device intended to protect secret information contained in the memory. In order to prevent access to the secret information by external browsing means, this device ensures that the secret information is distributed between two circuits, and the connection between the two circuits is established by various communication means, including an optoelectronic link, arranged in such a way that the least disturbance of the relative arrangement of the circuits results in an interruption in the link between the circuits.

### AIM OF THE INVENTION

Consequently, the general aim of the invention is to propose a new communicating portable object structure, notably a smart card or the like, that does not have the above disadvantages, and in particular a structure for optimizing the integration of a plurality of electronic modules in a smart card without adding peripheral components other than an antenna disposed in the card body.

Another aim of the invention is to allow the use, for the integration of electronic modules, of an already existing and well-controlled manufacturing method, namely, the simple addition of electronic modules in cavities provided in the card body.

### SUMMARY OF THE INVENTION

In principle, the solution according to the invention involves producing a cavity in the card body in order for each electronic module to be integrated, and involves ensuring that these cavities are located on opposite faces of the card at a carefully selected site, for example, that defined by standard ISO 7816-2. The electronic modules can be a standard size, namely, 13 mm by 11.8 mm or 11 mm by 8.3 mm. The electronic modules are generally inserted into cavities machined in the card body and having a first area machined to a depth P1 receiving the substrate of the module, and a second area machined to a depth P2 greater than P1 and receiving the microelectronic component of the module, which may or not be protected by a drop of protective resin. When two modules have to be disposed on the card body, several cases may arise.

Depending on the size of the modules used, and, consequently, on the size and depth of the cavities needed in the card body, the two depth cavities P1, or the two depth cavities P2, can be separate, or can even have an intersection area, i.e., at least one overlapping area in the main plane of the portable object. Several cases then may arise.

When the two depth cavities P1 or P2 are completely separate, metal armatures cannot be disposed therein that would enable a capacitive communication channel to be established between the two modules. However, an optical communication can be established between the modules by means of a waveguide integrated with the card body and extending between the two electronic modules or a radio frequency communication can be established between the two modules.

When only the two depth cavities P1 have at least one overlapping area in the main plane of the portable object and the two cavities P2 are completely separate, metal armatures can be disposed therein in order to establish a capacitive communication channel between the two electronic modules, but it is not possible to establish a direct module-to-module optical communication channel, unless a waveguide is used that is integrated with the card body or the intrinsic optical properties of the laminated layers (sufficiently translucent) and the proximity between the two modules are used. Furthermore, it is possible, in this case, to connect the two modules via a galvanic link in this overlapping area provided that one or more wells receiving a conductive element are produced beforehand.

When the two depth cavities P2 have an intersection area, a direct optical communication channel can be established between the two modules, without requiring a waveguide or light propagation through the materials located between the two modules.

The two electronic modules can include their own secondary antenna or coupling concentrator with the main antenna of the card body, but it is also possible to share a concentrator antenna between the two electronic modules.

Consequently, the invention relates to a communicating portable object with contactless or mixed contact and contactless operation, comprising a body integrating a main antenna capable of receiving electrical energy from an external reader via radio frequency and of communicating therewith, and two electronic modules each provided with a dielectric substrate having at least one microelectronic chip connected to an antenna disposed on each module and inductively coupled with the main antenna by means of a secondary antenna also integrated in the body and acting as a concentrator for inductively coupling with the antenna of each electronic module, the two electronic modules being located in two adjacent cavities located on opposite faces of the body, characterized in that said secondary antenna is arranged as a single concentrator whose turns are disposed around the overall area occupied by cavities receiving the two electronic modules.

According to another embodiment, the invention relates to a communicating portable object with contactless or mixed contact and contactless operation, comprising a body integrating a main antenna capable of receiving electrical energy from an external reader via radio frequency and of communicating therewith, and two electronic modules each provided with a dielectric substrate having at least one microelectronic chip connected to an antenna disposed on each module and inductively coupled with the main antenna by means of a secondary antenna also integrated in the body and acting as a concentrator for inductively coupling with the antenna of each electronic module, the two electronic modules being located in two adjacent cavities located on opposite faces of the body, characterized in that said secondary antenna is arranged as two distinct concentrators, with the turns of each concentrator dedicated to an electronic module only being disposed around the overall area occupied by a cavity receiving each electronic module.

According to one embodiment, the turns of the single concentrator or of the two distinct concentrators are inductively coupled with the antenna of each of said electronic modules.

According to one embodiment of the invention, said adjacent cavities of the body have an overlapping area in the main plane of the portable object, and this overlapping area can be complete or only partial,

According to one embodiment, one of the electronic modules is a main module capable of exchanging data with the external reader, and another electronic module is a secondary module provided with a biometric sensor or a display screen.

According to one embodiment, the main module is exposed on a first face of the portable object and the secondary module is exposed on the face opposite the first face of the communicating portable object.

According to one embodiment, each cavity comprises a first depth area P1 intended to receive the substrate of an electronic module and a second depth area P2 greater than P1 intended to receive at least one microelectronic component disposed on said substrate, and the two depth areas P1 are adjacent without an overlapping area in the main plane of the object.

According to another embodiment, each cavity comprises a first depth area P1 intended to receive the substrate of an electronic module and a second depth area P2 greater than P1 intended to receive at least one microelectronic component disposed on said substrate, and the two depth areas P1 have at least one overlapping area in the main plane of the object.

According to a first alternative embodiment, each cavity of the body comprises a first depth area P1 intended to receive the dielectric substrate of a first electronic module and a second depth area P2 greater than P1 intended to receive a second electronic module or a microelectronic component, and the two depth areas P2 are adjacent but separate. In this case, the two electronic modules can comprise electrically conductive pads intended to form the armatures of a capacitor once placed facing each other, so as to establish a capacitive communication channel between the two electronic modules.

According to another alternative embodiment, each cavity of the body comprises a first depth area P1 intended to receive the dielectric substrate of a first electronic module and a second depth area P2 greater than P1 intended to receive a second electronic module or a microelectronic component, and the two depth areas P2 are adjacent, but this time comprise an intersection area, so that the two cavities have a common cavity portion. In this specific case, the two electronic modules advantageously comprise at least one optoelectronic component so as to establish a direct optical communication channel between the two electronic modules via the common cavity portion. Furthermore, each electronic module can comprise a drop of coating resin for its electronic component, made of an optically transparent material.

According to one embodiment, said optical communication channel is produced via a waveguide.

According to one embodiment, said waveguide is produced either directly via the substrate of the main antenna, or via a complex supporting the antenna substrate and protective layers, or via non-opaque layers having a light transmission rate that is sufficient to allow optical communication,

According to one embodiment, said optical communication is established using the intrinsic optical properties of the constituent materials of the object.

The communicating portable object according to the invention can comprise a secondary antenna acting as a flux concentrator between the main antenna of the body and the antenna of each module. This concentrator antenna can be configured in various ways. According to one embodiment, said secondary antenna is arranged in the form of a single concentrator whose turns are disposed around the overall area occupied by the set of two electronic modules and are inductively coupled with the antenna of each of the modules. According to another embodiment, said secondary antenna is arranged in the form of two distinct concentrators, with the turns of each concentrator only being disposed around a dedicated electronic module and being mainly inductively coupled with the antenna of this electronic module.

The invention ensures that the two electronic modules can be arranged to transmit data from one to the other.

Depending on the respective positioning of the cavities receiving the two electronic modules, said modules can communicate via an optical, galvanic, capacitive, or inductive link. The two electronic modules also could be arranged to comprise an acoustic communication means.

Alternatively, the two electronic modules can be arranged to communicate with the external reader, without communicating with each other.

According to one embodiment, the two electronic modules are thin enough to be disposed in cavities of the body facing each other with a completely overlapping area of the cavities P1 and P2.

According to one embodiment, the communicating portable object is in the form of a smart card, and the electronic module of each face is disposed in an area of this face corresponding to the position defined by standard ISO 7816-2.

Further features and advantages of the invention will become apparent upon reading the detailed description provided for the application of the invention to a smart card, and with reference to the appended drawings, in which:

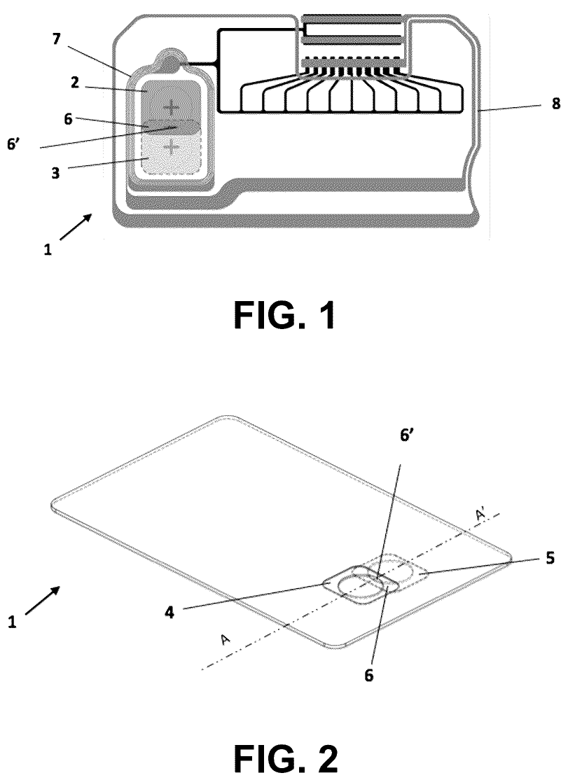

FIG. 1 shows a plan view of a first embodiment of a smart card according to the invention, showing an overlapping area of the cavities P1 and an intersection area of the cavities P2 disposed on each face of the smart card;

FIG. 2 shows the smart card of FIG. 1 as a three-dimensional perspective view;

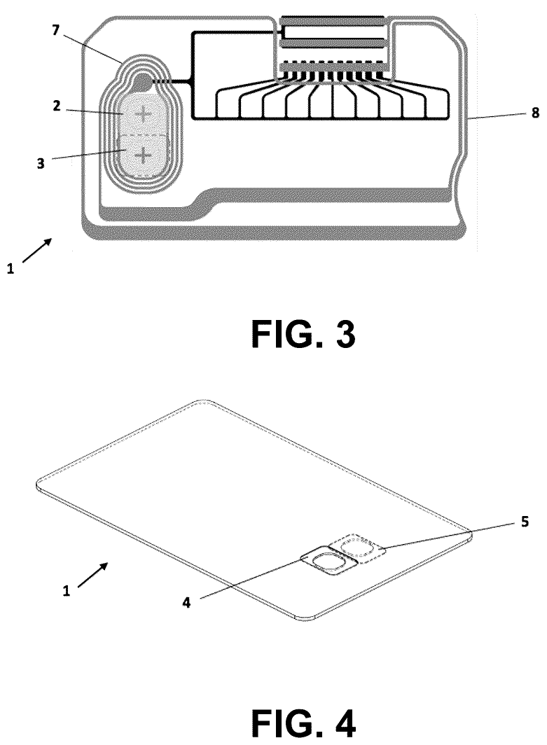

FIG. 3 shows a plan view of a second embodiment of a smart card according to the invention, in which the cavities of the card body are adjacent but without an overlapping area in the main plane of the smart card in their areas P1 and P2;

FIG. 4 shows the smart card of FIG. 3 as a three-dimensional perspective view;

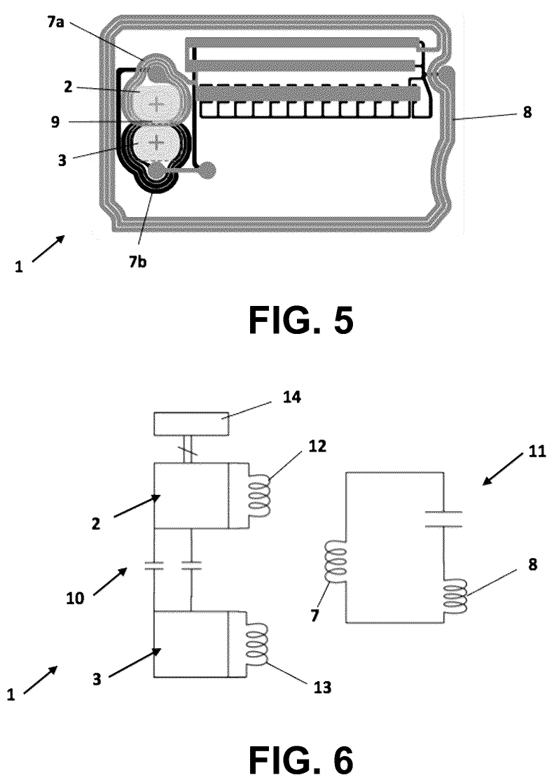

FIG. 5 shows a plan view of an alternative embodiment, in which two small electronic modules are used without an overlapping area of the depth cavities P1 and P2, with each module being surrounded by its own concentrator;

FIG. 6 shows an equivalent electrical diagram of an embodiment of the smart card of FIG. 1, with a capacitive link between the two electronic modules of the smart card, and a single concentrator antenna;

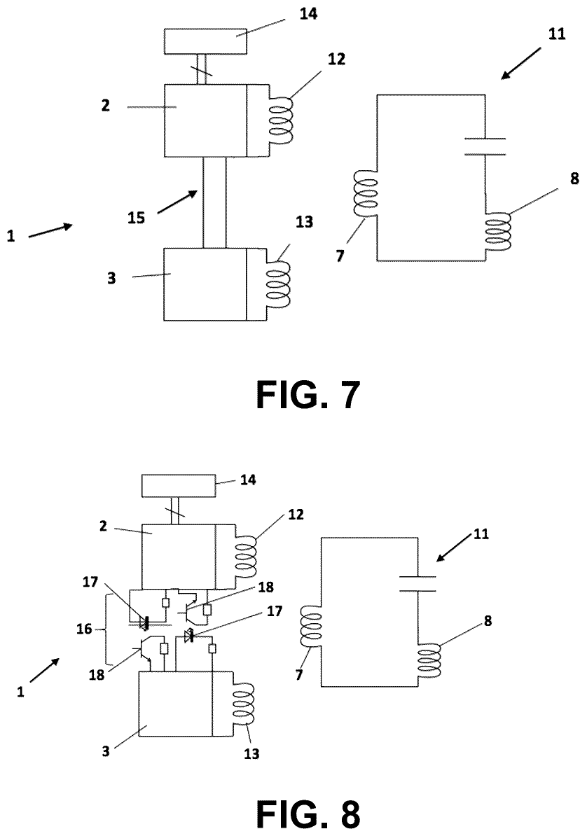

FIG. 7 shows an equivalent electrical diagram of an embodiment of the smart card of FIG. 1, with a galvanic link between the two electronic modules of the smart card, and a single concentrator antenna;

FIG. 8 shows an equivalent electrical diagram of an embodiment of the smart card of FIG. 1, with an optical link between the two electronic modules of the smart card, and a single concentrator antenna;

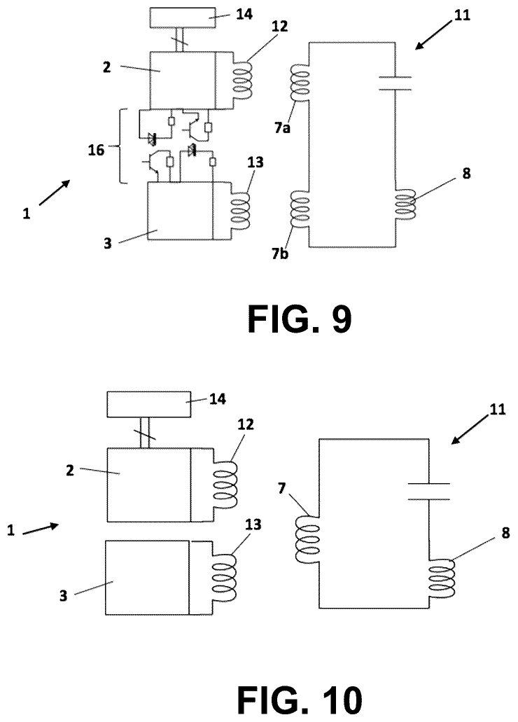

FIG. 9 shows an alternative embodiment of the electrical diagram of FIG. 5, with two concentrator antennas and an indirect optical link between the two electronic modules of the smart card, and two concentrator antennas;

FIG. 10 shows an equivalent electrical diagram of an embodiment of the smart card of FIG. 1, in which the two electronic modules of the smart card cannot communicate with each other;

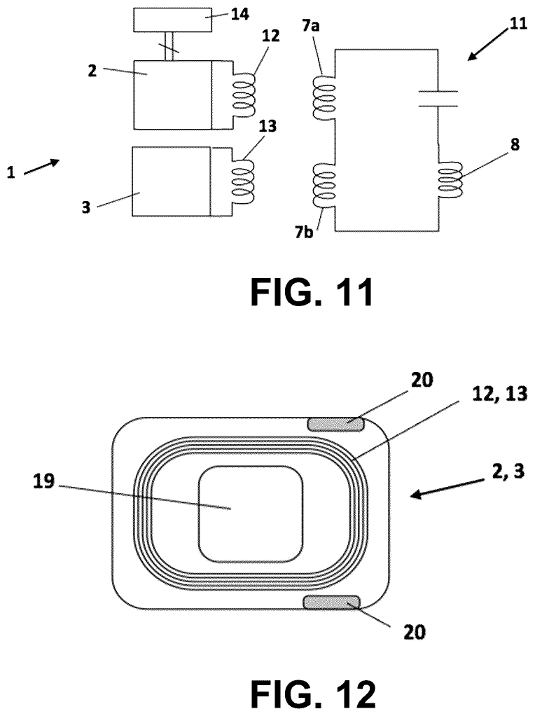

FIG. 11 shows an alternative embodiment of the electrical diagram of FIG. 10, with two concentrator antennas, according to the embodiment of FIG. 5;

FIG. 12 shows a plan view of an electronic module provided with a microelectronic chip, a module antenna, and metal blocks;

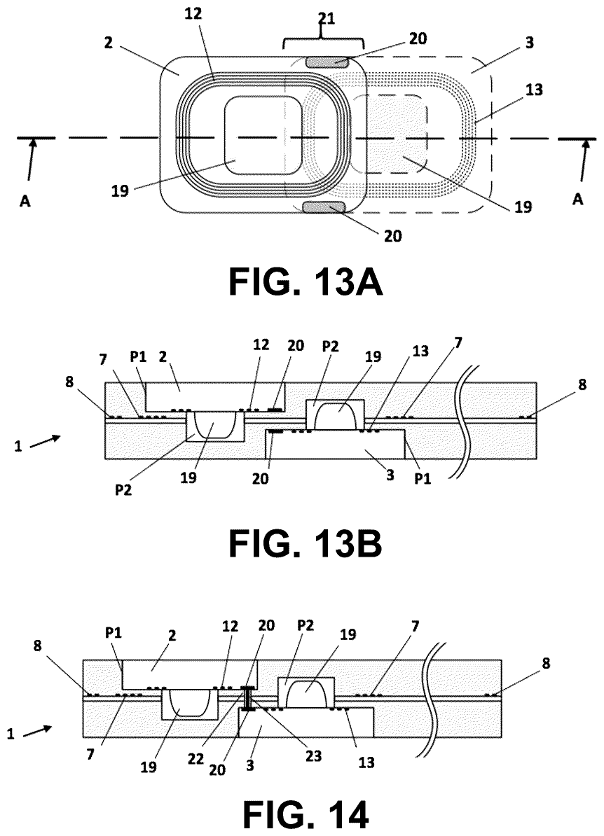

FIGS. 13A and 13B respectively show a plan view and a section view partially overlapping two electronic modules according to FIG. 12 and facing their respective metal blocks, with the corresponding electrical diagram being that of FIG. 6;

FIG. 14 shows a section view partially overlapping two electronic modules and facing their respective metal blocks connected by a galvanic connection, with the corresponding electrical diagram being that of FIG. 7;

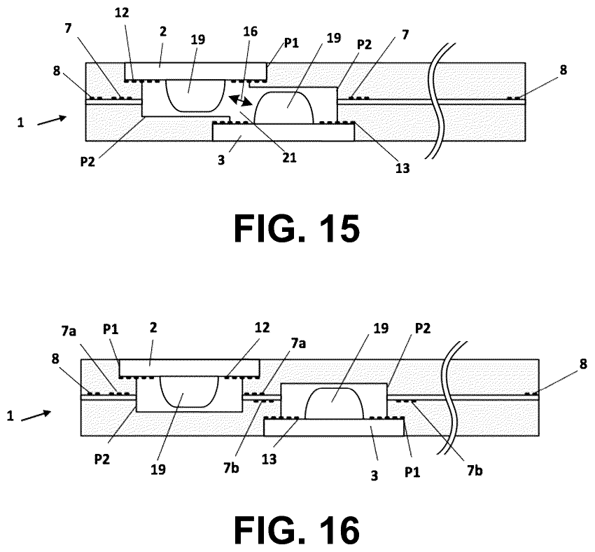

FIG. 15 shows a section view of a smart card according to the invention with a direct optical link or an inductive link between the two modules of the smart card;

FIG. 16 shows a section view of a smart card according to the invention without any communication between the two modules of the smart card corresponding to the equivalent diagram of FIG. 11;

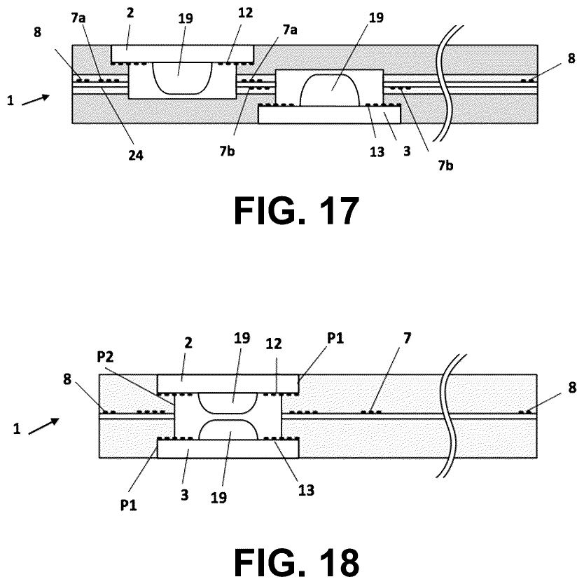

FIG. 17 shows a section view of a smart card according to the invention with two modules communicating with each other via an optical link using a waveguide produced by the antenna substrate of the card body or an inductive link;

FIG. 18 shows a section view of a smart card according to the invention with two thin electronic modules overlapping face-to-face in fully overlapping cavities P1 and P2.

### DETAILED DESCRIPTION

FIGS. 1 and 2 respectively show a plan and perspective view of a first embodiment of a smart card 1 according to the invention. It comprises two large electronic modules 2, 3, in the “dual 8” format, each inserted into a cavity 4, 5 produced on opposite faces of the smart card, at a position on each face that is defined by standard ISO 7816-2. Accordingly, the two cavities 4, 5 have an overlapping area 6 in their shallowest areas, called depth area, denoted P1, and an intersection area 6′ in their deepest areas, called depth area, denoted P2. The modules 2, 3 therefore partially face each other. Since the depth areas P2 of the two cavities have an intersection area 6′, a dedicated concentrator cannot be used for each module. The two modules 2, 3 are therefore surrounded by a single concentrator antenna 7, connected to a large main antenna 8 of the card body, typically in the “ID1” format, which allows radio frequency communication with an external reader.

If the cavities P2 are deep enough, they will have an intersection area that will allow the modules 2, 3 to be provided with an optical interface for direct optical communication between the 2 modules, as will be explained in further detail with reference to FIGS. 8 and 15.

FIGS. 3 and 4 are similar to FIGS. 1 and 2, except that the modules 2, 3 that are used are smaller, notably in the “dual 6” format. Accordingly, the cavities 4, 5 of the two modules 2, 3, seen as a plan view, are simply juxtaposed, without having an intersection area, neither in their depth area P1 (denoted cavity P1), nor in the depth area P2 (denoted cavity P2). A single concentrator 7 is shared between the two electronic modules 2, 3.

FIG. 5 shows a plan view of an embodiment similar to FIGS. 1 and 3, using two small format modules 2, 3, placed in cavities whose shallowest depth areas P1 are separated by a small space 9. In this case, the depth cavities P2 are also separated by a space that is larger than the small space 9, it is therefore possible to use a dedicated concentrator 7a, 7b for each module 2, 3, respectively surrounding each module, with each of the concentrators 7a, 7b being inductively coupled with the antenna (not shown) of one of the modules 2, 3.

FIG. 6 shows an equivalent electrical diagram of an embodiment of the smart card of FIG. 1. The communication between the two electronic modules 2, 3 occurs via a capacitive link 10 between metal armatures provided on each module. The booster antenna 11 of the smart card has a single concentrator antenna 7. Each of the electronic modules 2, 3 has its own antenna 12, 13 inductively coupled with the concentrator 7. In the example shown, the electronic module 2 can be a biometric module connected to a sensor or a display 14, and the electronic module 3 can be a conventional smart card security module.

FIG. 7 shows an equivalent electrical diagram similar to that of FIG. 6, except that the capacitive link 10 between the electronic modules 2, 3 is replaced by a galvanic connection 15.

FIG. 8 shows an equivalent electrical diagram of an embodiment of the smart card 1 of FIG. 1, with an optical link 16 between the two electronic modules 2, 3 of the smart card, and a single concentrator antenna 7.

Each module 2, 3 comprises a microcontroller and an optical communication stage comprising an emitting LED 17 and a receiving photodiode 18. The two modules 2, 3 are disposed in the smart card 1 such that the respective optical stages 17, 18 are preferably facing in order to define an optical path between the two modules. In particular, the optical wave, for example, the light emitted by the emitting LED 17 of a module, must be able to be picked up by the photodiode 18 of the other module. The optical communication occurs using any suitable protocol, for example, according to the “Li-Fi” protocol, and at any suitable wavelength, for example, but not necessarily, in the visible light spectrum.

FIG. 9 shows an equivalent electrical diagram similar to that of FIG. 8, except that the booster antenna 11 of the smart card 1 comprises two concentrators, namely, a respective concentrator 7a, 7b dedicated to each of the electronic modules 2, 3.

In FIG. 10, the two electronic modules, 2, 3, for example, a biometric module and a security module, are not connected to each other, but each can communicate with a remote reader (not shown) via its module antenna 12, 13, and the booster antenna 11 provided with a single concentrator 7.

FIG. 11 is similar to FIG. 10, except that the booster antenna 11 of the smart card 1 comprises two concentrators 7a, 7b, respectively dedicated to the electronic modules 2, 3.

FIG. 12 shows a single module 2, 3 with an encapsulation resin drop 19 for its microelectronic chip (not shown) and its antenna 12, 13, as well as metal areas 20 capable of forming capacitor armatures.

The interconnections between the chip, the antenna, and the metal blocks are not shown.

FIG. 13A shows a plan view of two electronic modules 2, 3 according to FIG. 12, overlapping and disposed with a partial overlapping area 21 corresponding to the overlapping area of the cavities P1 in the main plane. The metal armatures 20 of the two modules 2, 3 are then facing each other so as to establish a capacitive link between the two modules 2, 3, in accordance with the equivalent electrical diagram of FIG. 6.

FIG. 13B shows a transverse section view, A-A, of the smart card 1 reprising the stack of the modules 2, 3 of FIG. 13A. Each module 2, 3 is placed in a cavity comprising an area P1 receiving the substrate of the module and a deeper area P2 receiving the encapsulation drop 19 for the module. As can be seen, the two cavities P2 are separate, and the two cavities P1 have a partial overlapping area, in which facing metal armatures 20 are placed that form a capacitor for establishing a capacitive link between the two modules 2, 3.

FIG. 14 shows an embodiment similar to that of FIG. 13B, except that the metal blocks 20 are connected by a galvanic link 22 provided in a well 23 connecting the areas of the cavities P1 that are overlapping. This embodiment corresponds to the equivalent electrical diagram of FIG. 7.

FIG. 15 is a transverse section diagram of a smart card 1 according to the invention, with 2 cavities whose areas P2 have a common portion 21. One of the modules 2, 3 can be a DCVV display or a biometric module, with the other module preferably being a security module such as those that are well known in the field of bank smart cards. The modules 2, 3 each have a chip protected by an optically transparent encapsulation resin drop 19, so as to be able to establish a direct optical link 16 between the two modules, in accordance with the electrical diagram of FIG. 8.

FIG. 16 shows a section view of an embodiment in which neither the cavities P1 nor the cavities P2 of the two modules 2, 3 have an overlapping area, such that optical communication in principle is not possible. This embodiment corresponds to the equivalent electrical diagram of FIG. 11. The two modules 2, 3 do not communicate with each other, but each can communicate with a remote reader (not shown) via its dedicated concentrator 7a, 7b and the main antenna 8. Despite the separation of the cavities, in the event that the main polymer material forming the card 1 would have low enough opacity and that the modules 2, 3 would be close enough, an optical communication could occur and would correspond to the electrical diagram of FIG. 9.

FIG. 17 shows a section view of an embodiment similar to that of FIG. 16, except that the thickness of the card body comprises an optically transparent waveguide 24, and the encapsulation drops 19 for the chips are also optically transparent, allowing the two modules 2, 3 to communicate via an optical link, in accordance with the equivalent electrical diagram of FIG. 9.

The waveguide 24 can be produced in several ways: either directly by means of the substrate of the antenna or by a complex including the antenna substrate and protective layers, or by non-opaque layers, i.e., having a light transmission rate that is sufficient to allow optical communication, located inside the object or the smart card 1.

FIG. 18 shows a section view of an additional alternative embodiment, using two electronic modules 2, 3 that are thin enough to be able to be fully overlapping facing each other. In this case, the cavities P1 face each other, and the cavities P2 emerge into each other and completely overlap in a plan view. The galvanic, optical, capacitive and inductive connection modes between the modules are possible.

### Advantages of the invention

Ultimately, the invention allows a communicating portable object, notably a smart card or an electronic passport, to achieve the stated aims.

In particular, the specific placement of the electronic modules and the cavities of the card body so as to be adjacent or partially or completely overlapping eliminates the need for a PCB printed circuit, which helps to reduce the manufacturing cost of the smart card and increase the manufacturing yield. Furthermore, the structure of the smart card according to the invention is compatible with the usual low cost and high yield manufacturing methods that involve integrating electronic modules into surface cavities of the card body.

The proposed technology allows several different types of electronic modules to easily integrate and communicate in a smart card or in an equivalent communicating device, without requiring wired connections between the modules, which means that the devices will be particularly resistant to reliability tests and will have a longer service life. This simplification of the complex card manufacturing mode will make it easier to deploy these technologies in the market.

The communication between the electronic modules, whether or not it is optical, is also facilitated and secured, so that the proposed solution is particularly secure and is difficult for a potential fraudster to subvert.

1. A communicating portable object with contactless or mixed contact and contactless operation, comprising a body integrating a main antenna capable of receiving electrical energy from an external reader via radio frequency and of communicating therewith, and two electronic modules each provided with a dielectric substrate having at least one microelectronic chip connected to an antenna disposed on each module and inductively coupled with the main antenna using a secondary antenna also integrated in the body and acting as a concentrator for inductively coupling with the antenna of each electronic module the two electronic modules being located in two adjacent cavities located on opposite faces of the body, wherein the secondary antenna is arranged as a single concentrator whose turns are disposed around the overall area occupied by cavities receiving the two electronic modules

2. A communicating portable object with contactless or mixed contact and contactless operation, comprising a body integrating a main antenna capable of receiving electrical energy from an external reader via radio frequency and of communicating therewith, and two electronic modules each provided with a dielectric substrate having at least one microelectronic chip connected to an antenna disposed on each module and inductively coupled with the main antenna using a secondary antenna also integrated in the body and acting as a concentrator for inductively coupling with the antenna of each electronic module the two electronic modules being located in two adjacent cavities located on opposite faces of the body, wherein the secondary antenna is arranged as two distinct concentrators with the turns of each concentrator dedicated to an electronic module only being disposed around the overall area occupied by a cavity receiving each electronic module

3. The communicating portable object of claim 1, wherein the turns of the single concentrator or of the two distinct concentrators are inductively coupled with the antenna of each of said electronic modules

4. The communicating portable object of claim 1, wherein said adjacent cavities have a partial or completely overlapping area in the main plane of the portable object.

5. The communicating portable object of claim 1, wherein one of the electronic modules is a main module capable of exchanging data with an external reader and in that the other electronic module is a secondary module provided with a biometric sensor or a display screen.

6. The communicating portable object of claim 5, wherein the main module is exposed on a first face of the communicating portable object and the secondary module is exposed on the face opposite the first face of the communicating portable object.

7. The communicating portable object of claim 5, wherein each cavity comprises a first depth area P1 intended to receive the substrate of an electronic module and a second depth area P2 greater than P1 intended to receive at least one microelectronic component disposed on said substrate, and wherein the two depth areas P1 are adjacent without an overlapping area in the main plane of the object.

8. The communicating portable object of claim 5, wherein each cavity comprises a first depth area P1 intended to receive the substrate of an electronic module and a second depth area P2 greater than P1 intended to receive at least one microelectronic component disposed on said substrate, and wherein the two depth areas P1 have at least one overlapping area in the main plane of the object.

9. The communicating portable object of claim 1, wherein each cavity comprises a first depth area P1 intended to receive the substrate of an electronic module and a second depth area P2 greater than P1 intended to receive at least one microelectronic component disposed on said substrate, and wherein the two depth areas P2 are adjacent but separate.

10. The communicating portable object of claim 1, wherein each cavity comprises a first depth area P1 intended to receive the substrate of an electronic module and a second depth area P2 greater than P1 intended to receive at least one microelectronic component disposed on said substrate, and wherein the two depth areas P2 are adjacent and comprise an intersection area so that the two cavities have a common cavity portion.

11. The communicating portable object of claim 10, wherein the two electronic modules comprise at least one optoelectronic component so as to establish a direct optical communication channel between the two electronic modules via said common cavity portion.

12. The communicating portable object of claim 1, to wherein the two electronic modules comprise at least one optoelectronic component so as to establish an optical communication channel between the two electronic modules with said optical communication being established via a waveguide.

13. The communicating portable object of claim 12, wherein the waveguide is produced:
directly via the substrate of the main antenna or
via a complex supporting the antenna substrate and protective layers; or
via non-opaque layers having a light transmission rate that is sufficient to allow optical communication.

14. The communicating portable object of claim 1, wherein the two electronic modules comprise at least one optoelectronic component so as to establish an optical communication channel between the two electronic modules with said optical communication being established using the intrinsic optical properties of the constituent materials of the object.

15. The communicating portable object of claim 11, wherein each electronic module comprises a drop of coating resin for its microelectronic component made of an optically transparent material.

16. The communicating portable object of claim 1, wherein the two electronic modules comprise electrically conductive pads configured to form the armatures of a capacitor when facing each other, so as to establish a capacitive communication channel between the two electronic modules

17. The communicating portable object of claim 1, wherein:
the antennas of the two electronic modules are configured to allow communication via inductive coupling; or the two electronic modules comprise acoustic communication means.

18. (canceled)

19. The communicating portable object of claim 1, wherein the two electronic modules are designed to:
transmit data from one to the other; or
communicate with an external reader, without communicating with each other.

20. (canceled)

21. The communicating portable object of claim 1, wherein:
the two electronic modules are thin enough to be disposed in cavities of the body facing each other with a completely overlapping area of the cavities P1 and P2; or
the communicating portable object is in the form of a smart card.

22. (canceled)

23. The communicating portable object of claim 21, wherein at least one of the two electronic modules is disposed in an area corresponding to the position defined by standard ISO 7816-2.
